(19) United States
(12) Patent Application Publication
(10) Pub. No.: US 2017/0034651 A1
(43) Pub. Date: Feb. 2, 2017

(54) NETWORK-CONNECTED SEMI-FIXED LOCATION TELEPHONE WITH ENVIRONMENTAL SENSOR, AND RELATED COMPONENTS, SYSTEMS, AND METHODS

(71) Applicant: Avaya Inc., Santa Clara, CA (US)

(72) Inventors: John H. Yoakum, Cary, NC (US); Clark D. Petrie, Colts Neck, NJ (US)

(21) Appl. No.: 14/812,348

(22) Filed: Jul. 29, 2015

(51) Int. Cl. H04W 4/02

(52) U.S. Cl. CPC H04W 4/02

(57) ABSTRACT

A network-connected semi-fixed location telephone is disclosed having a network access transceiver configured to provide access to a network for computing devices in communication therewith. The network-connected semi-fixed location telephone also comprises one or more environmental sensors each configured to determine at least one environmental characteristic value that quantifies an environmental characteristic at a location outside the network-connected semi-fixed location telephone. Without limitation, environmental characteristics include temperature, humidity, sound, light, motion, and air quality, The network-connected semi-fixed location telephone further comprises a sensor controller in communication with the at least one environmental sensor. The sensor controller may be separate from the network access transceiver or may be part of the same component. The sensor controller is configured to receive the at least one environmental characteristic value from the at least one environmental sensor, and transmit information based on the at least one environmental characteristic value to a network.

### RELATED APPLICATIONS

This application is related to “NETWORK-CONNECTED LIGHTING STRUCTURE WITH CLIMATE SENSOR, AND RELATED COMPONENTS, SYSTEMS, AND METHODS,” (Application No. TBD) filed on Jul. 29, 2015, the disclosure of which is hereby incorporated herein by reference in its entirety.

This application is related to “NETWORK-CONNECTED ACCESS POINT WITH ENVIRONMENTAL SENSOR, AND RELATED COMPONENTS, SYSTEMS, AND METHODS,” (Application No. TBD) filed on Jul. 29, 2015, the disclosure of which is hereby incorporated herein by reference in its entirety.

### TECHNICAL FIELD

This disclosure is related to a semi-fixed location telephone, and more specifically to a network-connected semi-fixed location telephone with an environmental sensor, and related components, systems, and methods.

### BACKGROUND

As wireless networks and internet access become more commonplace and ubiquitous, network connectivity is now being added to a variety of different devices, including those devices not commonly associated with computing applications. This phenomenon is commonly referred to as the “Internet of Things” (IoT). For many widely deployed devices, these newly added network functions enhance and extend beyond their main functionality. For example, a network-connected thermostat may enable remote control and monitoring of temperature characteristics in a dwelling or other structure. However, this connectivity also permits additional functionality that may not be directly related to the device's primary functionality, or that may interact with the device's primary functionality in unexpected ways.

### SUMMARY

Embodiments include a network-connected semi-fixed location telephone with an environmental sensor, and related components, systems, and methods. In one embodiment, a network-connected semi-fixed location telephone comprises one or more telecommunication transceivers with associated processor and memory that controls data transmissions, and an interface to a network configured to provide access to a telecommunication network for users. The network-connected semi-fixed location telephone also comprises at least one environmental sensor each configured to determine at least one environmental characteristic value that quantifies an environmental characteristic at a location outside the network-connected semi-fixed location telephone. As non-limiting examples, environmental characteristics include temperature, humidity, sound, light, motion, and air quality. The network-connected semi-fixed location telephone further comprises a sensor controller in communication with the at least one environmental sensor. The sensor controller may be separate from the controller within the network-connected semi-fixed location telephone that controls data transmissions or may be part of the same component. The sensor controller is configured to receive the at least one environmental characteristic value from the at least one environmental sensor and transmit information based on the at least one environmental characteristic value to a network, which can be the same as the first network or a different network. One advantage of this arrangement is that a number of semi-fixed location telephones within a building can gather individual data points relating to one or more environmental characteristics within a defined area, such as a shared space in an office building or a climate-monitored space within a warehouse. Because each semi-fixed location telephone is stationary with a known (or knowable) location, the individual data points can be used to determine environmental properties of different sub-areas within the defined area. This also has the advantage of providing additional functionality to the semi-fixed location telephone that is separate from the primary function of the semi-fixed location telephone, and that leverages the distributed locations of the semi-fixed location telephones to provide these new functions.

According to one embodiment, a network-connected semi-fixed location telephone device is disclosed. The network-connected semi-fixed location telephone device comprises a telecommunication transceiver configured to provide access to a telecommunication network for a user. The network-connected semi-fixed location telephone device further comprises at least one environmental sensor configured to determine at least one environmental characteristic value that quantifies an environmental characteristic at a location outside the network-connected semi-fixed location telephone device. The network-connected semi-fixed location telephone device further comprises a sensor controller in communication with the at least one environmental sensor. The sensor controller is configured to receive the at least one environmental characteristic value from the at least one environmental sensor. The sensor controller is further configured to transmit information based on the at least one environmental characteristic value to a network.

According to another embodiment, a network-connected semi-fixed location telephone system is disclosed. The system comprises a system controller. The system further comprises a plurality of semi-fixed location telephones in communication with the system controller via a system network. Each semi-fixed location telephone comprises a one or more telecommunication transceivers with associated processor and memory and a network interface unit configured to provide access to a telecommunication network for one or more users in communication with the telecommunication transceivers. Each semi-fixed location telephone further comprises at least one environmental sensor configured to determine at least one environmental characteristic value that quantifies an environmental characteristic at a location outside the semi-fixed location telephone. Each semi-fixed location telephone further comprises a sensor controller in communication with the at least one environmental sensor. The sensor controller is configured to receive the at least one environmental characteristic value from the at least one environmental sensor. The sensor controller is further configured to transmit information based on the at least one environmental characteristic value to the sensor controller via the system network.

According to another embodiment, an environmental sensor assembly is configured to be connected to a network-connected semi-fixed location telephone device. The assembly comprises at least one environmental sensor configured to determine at least one environmental characteristic value that quantifies an environmental characteristic at a location outside the semi-fixed location telephone device. The assembly further comprises a sensor controller in communication with the at least one environmental sensor. The sensor controller is configured to receive the at least one environmental characteristic value from the at least one environmental sensor. The sensor controller is further configured to transmit information based on the at least one environmental characteristic value to a network via the semi-fixed location telephone device.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a schematic diagram of a network-connected semi-fixed location telephone device according to an embodiment;

FIG. 2 illustrates a schematic diagram of a network-connected lighting system for a multi-story structure employing the semi-fixed location telephones of FIG. 1 according to an embodiment;

FIG. 3 illustrates a schematic diagram of a floor plan having an array of semi-fixed location telephones of FIG. 1 according to an embodiment;

FIG. 4 illustrates a schematic diagram of a network-connected semi-fixed location telephone device according to an alternative embodiment; and

FIG. 5 illustrates a block diagram of a network-connected semi-fixed location telephone device according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first configuration” and “second configuration,” and does not imply a priority, a type, an importance, or other attribute, unless otherwise stated herein.

Embodiments include a network-connected semi-fixed location telephone with an environmental sensor, and related components, systems, and methods. In one embodiment, a network-connected semi-fixed location telephone comprises one or more telecommunication transceivers with associated processor and memory that controls data transmissions, and an interface to a network configured to provide access to a telecommunication network for users. The network-connected semi-fixed location telephone also comprises at least one environmental sensor each configured to determine at least one environmental characteristic value that quantifies an environmental characteristic at a location outside the network-connected semi-fixed location telephone. As non-limiting examples, environmental characteristics include temperature, humidity, sound, light, motion, and air quality. The network-connected semi-fixed location telephone further comprises a sensor controller in communication with the at least one environmental sensor. The sensor controller may be separate from the controller within the network-connected semi-fixed location telephone that controls data transmissions or may be part of the same component. The sensor controller is configured to receive the at least one environmental characteristic value from the at least one environmental sensor and transmit information based on the at least one environmental characteristic value to a network, which can be the same as the first network or may be a different network. For example, the sensor controller and telecommunication transceivers may both be configured to communicate via a common internet-protocol (IP) network. One advantage of this arrangement is that a number of semi-fixed location telephones within a building can gather individual data points relating to one or more environmental characteristics within a defined area, such as a shared space in an office building or a climate-monitored space within a warehouse. Because each semi-fixed location telephone is stationary with a known (or knowable) location, the individual data points can be used to determine environmental properties of different sub-areas within the defined area. This also has the advantage of providing additional functionality to the semi-fixed location telephone that is separate from the primary function of the semi-fixed location telephone, and that leverages the distributed locations of the semi-fixed location telephones to provide these new functions.

As used herein, the term “semi-fixed location telephone” refers to a device which provides access to a telecom network for one or more users, and which is intended to be installed permanently or semi-permanently at a known or knowable location. Such semi-fixed location telephones may use a public switched telephone network (PTSN), voice over IP (VoIP), or other technologies that facilitate the connection of computing or other devices to a data or communication network. Many semi-fixed location telephones are configured to be attached to a surface of a wall, or may be installed at a desk or other piece of furniture, and may be attached to a track structure. Semi-fixed location telephones may provide access to a single telecom network, or to a plurality of telecom networks, and may also provide access to other types of networks, such as internet protocol (IP) or other data networks. Different networks may be associated with a single semi-fixed location telephone or multiple semi-fixed location telephones creating a single larger coverage area for the network.

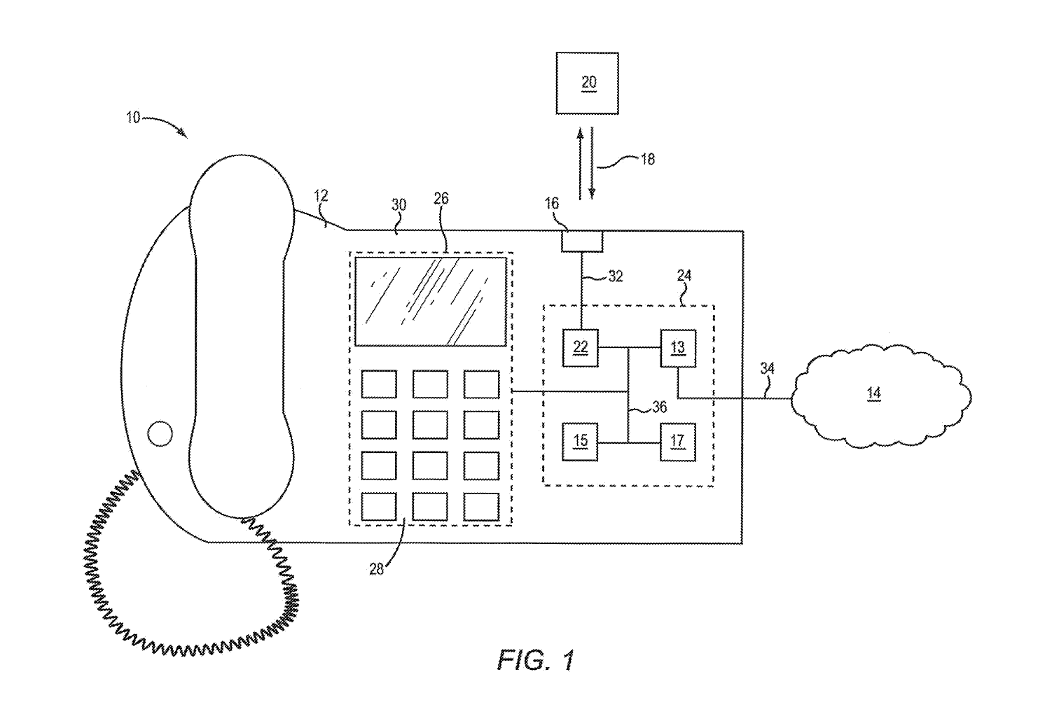

In this regard, FIG. 1 illustrates a network-connected semi-fixed location telephone 10 according to an embodiment. The network-connected semi-fixed location telephone 10 comprises a telephone component 12 comprising one or more telecom transceivers connected to a network interface unit 13 to provide access to a network 14, such as a telecom and/or data network, for one or more users.

The telephone component 12 is controlled by a processor unit 15 and may also include a memory 17. The semi-fixed location telephone 10 further comprises at least one environmental sensor 16 configured to determine at least one environmental characteristic value that quantifies an environmental characteristic 18 at a location outside the semi-fixed location telephone 10, such as an object 20 or an area in a vicinity of the semi-fixed location telephone 10. The vicinity may be in an immediate vicinity or may be distant, i.e., outside the immediate vicinity of the semi-fixed location telephone 10. The semi-fixed location telephone 10 further comprises a sensor controller 22 in communication with the at least one environmental sensor 16. The sensor controller 22 is configured to receive the at least one environmental characteristic value from the at least one environmental sensor 16 and transmit information based on the at least one environmental characteristic value to the network 14. In this embodiment, the information is transmitted on the same network 14 as the one used by the network interface unit 13. It should be understood, however, that the network interface unit 13 and the sensor controller 22 may also be associated with different networks. The processor unit 15, memory 17, and network interface unit 13 may also be referred to as a telecom module 24. In this embodiment, the sensor controller 22 is part of the telecom module 24, but it should be understood that the sensor controller 22 may be a separate component as well.

In this embodiment as well, the sensor controller 22 is configured to determine the information based on the at least one environmental characteristic value prior to transmitting the information to the network 14. It should be understood that the information may include the raw environmental characteristic value, and may also include information derived from the environmental characteristic value or information corrected to account for various impacts associated with known characteristics of the semi-fixed location telephone 10.

In this example, the semi-fixed location telephone 10 is installed at an office desk or other piece of furniture, or on a wall, and may be permanently or semi-permanently installed in a known or knowable location on or inside a structure. The information to be transmitted to the network 14 may also include location information corresponding to the installation location of the semi-fixed location telephone 10.

In this embodiment, the semi-fixed location telephone 10 may include a user interface such as a display 26 and/or keypad 28 for allowing the user to control the telecom and other functions of the semi-fixed location telephone 10. In this embodiment, the telephone component 12 and the sensor controller 22 are disposed in a housing 30, and the display 26 and keypad 28 are disposed on the outside of the housing 30. In this example, the environmental sensor 16 is a motion sensor pointed at the object 20 within the line-of-sight of the environmental sensor 16. Here, the environmental sensor 16 is configured to detect movement corresponding to the environmental characteristic 18, i.e., an object in motion, such as the object 20 in a location within the line-of-sight of the environmental sensor 16.

Other types of environmental sensors 16 include temperature sensors configured to detect infrared radiation corresponding to a temperature of an object or area. It should be understood that some types of temperature sensors may be configured to detect infrared radiation in a conical region corresponding to the climate characteristic in a defined area, such as an area intended to be inhabited or monitored, rather than a climate characteristic of an individual object.

It should also be understood that other types of environmental sensors 16 may be used, such as a laser-based temperature sensor, a thermistor, a humidity sensor, an audio sensor, a video sensor, a still or a video camera, or other sensor that is capable of detecting a temperature, humidity, barometric pressure, or other climate characteristic at a location away from the semi-fixed location telephone 10. For example, the environmental sensor 16 may be configured to detect a sonic characteristic, such as a voice or a predetermined sound type, such as breaking glass. The environmental sensor 16 may also be configured to detect an ambient light characteristic, such as a brightness, a color, an illumination pattern, or a change in a brightness, color, or illumination pattern. The environmental sensor 16 may also include a still or video camera in some embodiments. The environmental sensor 16 may also be configured to detect an air quality condition, such as an air visibility level or a presence of smoke. The environmental sensor 16 may also be configured to detect electromagnetic radiation, such as ambient radiation or a man-made electromagnetic signal. For example, the environmental sensor 16 may be configured to detect the presence of a radio frequency identification (RFID) circuit within a detection range of the environmental sensor 16.

It should be understood that some types of sensors may be unsuitable for use with the semi-fixed location telephone 10. For example, in some embodiments, the environmental characteristic 18 may be an ambient climate characteristic that is outside the semi-fixed location telephone 10. This is in contrast to an immediate ambient climate characteristic of the area in the immediate vicinity of the semi-fixed location telephone 10. In this regard, a temperature gauge that is configured to monitor an immediate ambient climate characteristic of the semi-fixed location telephone 10 itself, or in the immediate vicinity thereof, would not be configured to also detect an environmental characteristic 18 at a location away from the semi-fixed location telephone 10. This is because an ambient temperature of the semi-fixed location telephone 10 may be significantly different than the ambient temperature of the object 20 at a remote location away from the semi-fixed location telephone 10. In other embodiments, the semi-fixed location telephone 10 may not consume sufficient power to generate significant heat, in which case the environmental sensor 16 designed to measure immediate climate characteristics may be an appropriate choice as a sensor. In this embodiment, should power consumption by the semi-fixed location telephone 10 increase over a period of time, a flag (not shown) could be stored in memory (not shown) to alert a climate monitoring server (not shown) that an immediate ambient climate measurement may not be accurate and should be disregarded. Such a flag could be changed in memory after a period of lower power consumption by the semi-fixed location telephone 10.

In this embodiment, the environmental sensor 16 is connected to the sensor controller 22 by a wired sensor connection 32, but it should be understood that the environmental sensor 16 may alternatively use a wireless communication connection, such as a wireless transmitter, a receiver, and/or a transceiver in other embodiments. Likewise, in this embodiment, the sensor controller 22 is connected to the network 14 via a wired network connection 34, but it should also be understood that the environmental sensor 16 may alternatively use a wireless communication connection in other embodiments. The wired network connection 34 in this embodiment may include separate power and network (e.g., Ethernet) connections, or may alternatively employ a single connection, such as an Ethernet connection employing Power over Ethernet (PoE) or a similar protocol. In this embodiment, the processor unit 15 is connected to the network 14 through the network interface unit 13 via a wired connection 36, but here again, it should be understood that in other embodiments, the processor unit 15 may be connected directly to the network 14 via wired or wireless connections.

In this embodiment, the environmental sensor 16 is a stationary directional motion sensor. It should be understood, however, that other types of environmental sensors 16 may be used. For example, the environmental sensor 16 may have one or more adjustable parameters, such as direction, focus, intensity, or other parameters. For example, the environmental sensor 16 may have a first configuration configured to determine at least one environmental value that quantifies the environmental characteristic 18 at a first location outside the semi-fixed location telephone 10, and a second configuration configured to determine at least one environmental characteristic value that quantifies the environmental characteristic 18 at a second location outside the semi-fixed location telephone 10. The parameters may be adjusted manually, remotely, or automatically in response to a determined parameter, for example, via the sensor controller 22. The connection of the sensor controller 22 to the network 14 may also provide for remote discovery, broadcast, provisioning, or reporting of the individual environmental sensors 16 and their respective locations. In another example, the sensor controller 22 may have connectivity to a building thermostat, such that the sensor controller 22 can adjust local temperature settings based on a determined climate characteristic value from the environmental sensor(s) 16. Such connectivity between the sensor controller 22 and building thermostat may be through the network interface unit 13, for example.

In this embodiment, the object 20 is illustrated as being located remotely from the semi-fixed location telephone 10. For example, the object 20 may be located on a floor of a structure, or may be part of a piece of furniture in the same room as the semi-fixed location telephone 10. Notably, the environmental sensor 16 is not configured to detect the environmental characteristic 18 of the semi-fixed location telephone 10 itself. For example, an electrical structure, such as the semi-fixed location telephone 10, may have an internal temperature or other characteristic significantly different than the environmental characteristic 18 of the object 20 or the location being measured by the environmental sensor 16. In fact, using the environmental sensor 16 configured to detect the environmental characteristic 18 within or in close proximity to the semi-fixed location telephone 10 may not be suitable for determining the environmental characteristic 18 of the object 20 or the location. This is because the altered characteristic in and around the semi-fixed location telephone 10 may not accurately reflect the actual environmental characteristics 18 within the overall space in which the semi-fixed location telephone 10 is installed. In some embodiments, corrections may be applied by the sensor controller 22 to eliminate impacts from the semi-fixed location telephone 10 to the area immediately around it.

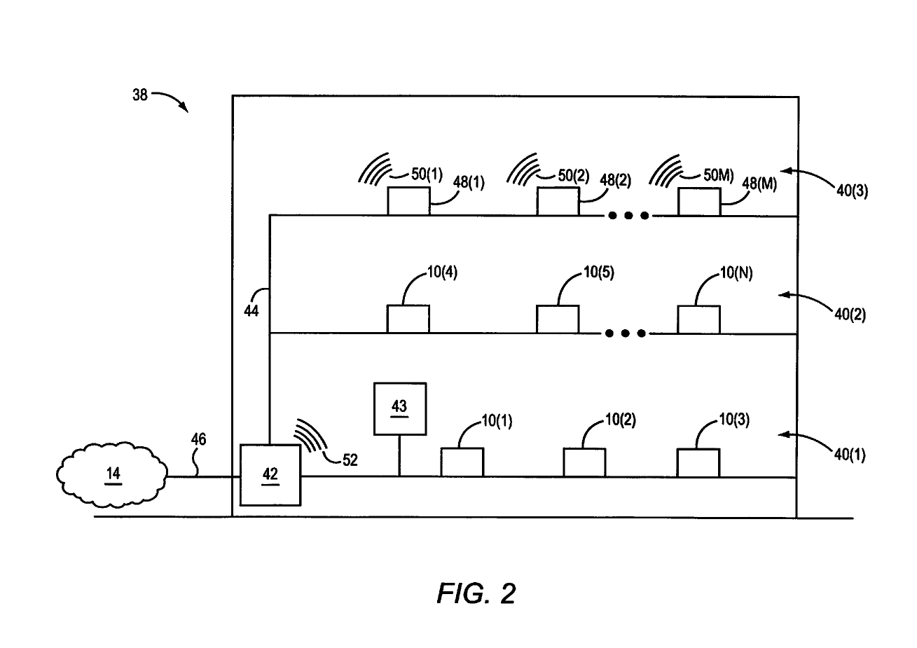

Because most structures have semi-fixed location telephones distributed throughout the structure, it becomes possible to gather detailed and granular information about the various climate characteristics within the structure. In this regard, FIG. 2 illustrates a diagram of a multi-story building 38 having a plurality of floors 40(1)-40(3). In this embodiment, a plurality of semi-fixed location telephones 10(1)-10(N) are distributed across the floors 40(1) and 40(2). Each semi-fixed location telephone 10(1)-10(N) is in communication with a centralized system controller 42, for example, via the respective network interface unit 13 (see FIG. 1) of each semi-fixed location telephone 10(1)-10(N). In this embodiment, each semi-fixed location telephone 10(1)-10(N) is in communication with the system controller 42 via a wired controller connection 44. The system controller 42 is connected to the larger network 14, such as the internet, via a communication channel 46.

It may also be desirable, however, to include wireless functionality that is capable of operating as an alternative mechanism for communicating with the system controller 42 in addition to providing network access. In this regard, the floor 40(3) of the building 38 includes a plurality of alternative semi-fixed location telephones 48(1)-48(M). In this embodiment, the internal components of each semi-fixed location telephone 48(1)-48(M) is similar to the internal components of the semi-fixed location telephone 10 of FIG. 1. In this embodiment, however, rather than requiring a hard wired connection to the system controller 42, each semi-fixed location telephone 48(1)-48(M) communicates with the system controller 42 via a wireless transceiver 50(1)-50(M). The wireless transceivers 50(1)-50(M) may be configured to communicate with each other, and to also communicate with a complementary wireless transceiver 52 in the system controller 42.

In this embodiment, the system controller 42 is able to have connectivity to all of the semi-fixed location telephones 10(1)-10(N), 48(1)-48(M) simultaneously, thereby allowing the system controller 42 to determine real time information with regard to environmental characteristics 18 throughout the building 38, as well as coordinate network coverage for the different semi-fixed location telephones 10(1)-10(N), 48(1)-48(M). This real time information can be used, for example, to control an HVAC system, an alarm or condition detection system, or to communicate sensor functionality of the semi-fixed location telephones 10(1)-10(N), 48(1)-48(M) to an installer or a technician. In another non-limiting embodiment, multiple systems or applications may use the determined climate characteristic value and/or information concurrently. For example, these systems or applications may be in communication with the system controller 42, connected to the network 14, or both. It should be noted, however, that the sensor controller 22 (not shown) in each semi-fixed location telephone 10(1)-10(N), 48(1)-48(M) may communicate with a separate environment controller 43. In this alternative embodiment, system controller 42 may provide a switching or routing function to direct the sensor controller 22 to the environment controller 43 via network 14 or an alternative network.

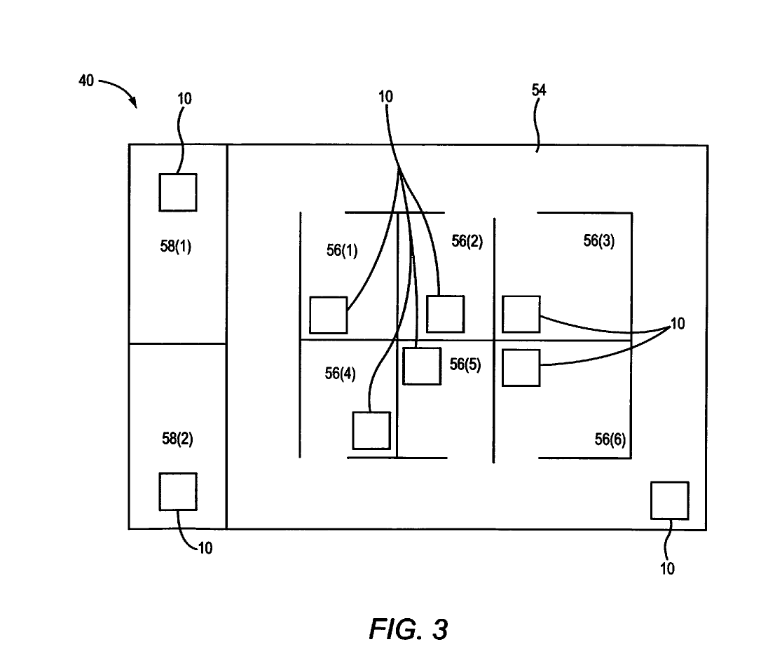

In this regard, FIG. 3 illustrates an exemplary simplified floorplan of one of the floors 40(1)-40(3) of the building 38 of FIG. 2. In this example, the floor 40 includes a common area 54 in which a plurality of open cubicles 56(1)-56(6) are arranged. In this example, the floor 40 also includes a pair of closed offices 58(1) and 58(2). In this embodiment, each cubicle 56(1)-56(6) and each office 58(1), 58(2) has a semi-fixed location telephone 10, thereby distributing the semi-fixed location telephones 10 across the floor 40 in this embodiment. As shown in FIG. 3, the semi-fixed location telephones 10 may be positioned and distributed such that each area of the floor 40 is within range of at least one semi-fixed location telephone 10. Thus, detailed and specific information about any number of environmental characteristics 18 (not shown) may be determined for a number of different specific locations within the floor 40.

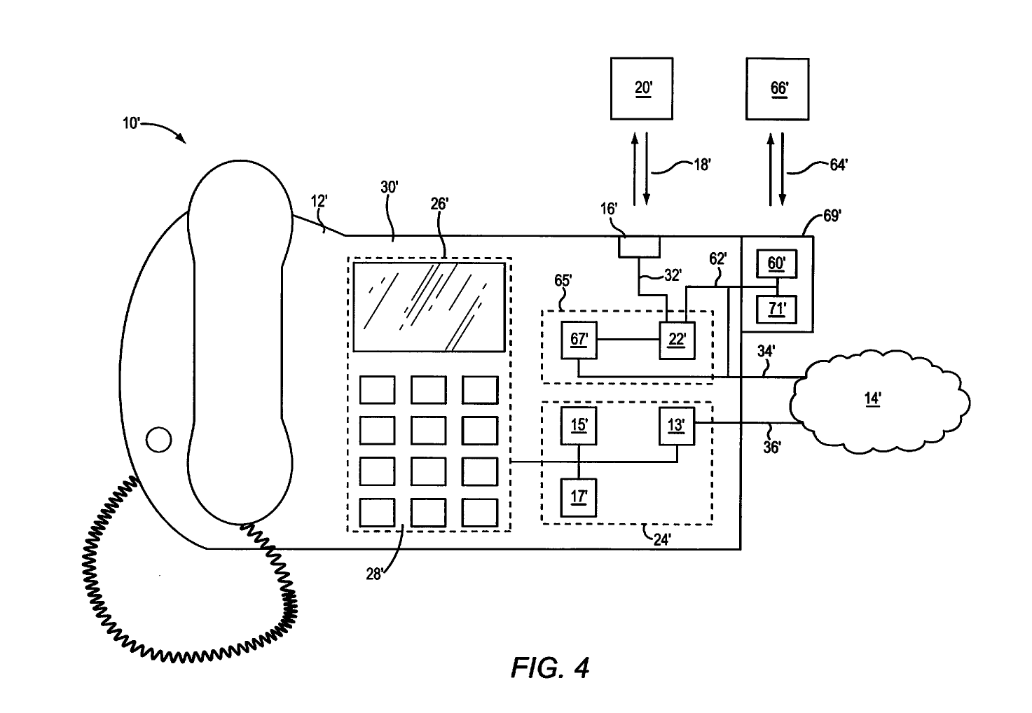

It should be understood that the environmental sensor 16 is not required to be disposed within or otherwise attached to the housing 30 of the semi-fixed location telephone 10 to function properly. In this regard, FIG. 4 illustrates a semi-fixed location telephone 10′ according to an alternative embodiment, in which an environmental sensor 16′ is located inside a housing 30′ of the semi-fixed location telephone 10′, and a second environmental sensor 60′ is disposed outside the housing 30′. It should also be understood that a sensor controller 22′ and a processor unit 15′ may be separate elements and may even be separately connected to network 14′. In another embodiment, the sensor controller 22′ and the processor unit 15′ may be separately connected to different networks. As with FIG. 1, the environmental sensor 16′ of FIG. 4 is connected to the sensor controller 22′ via a wired sensor connection 32′. In this embodiment, also, the processor unit 15′ is separately connected to the network 14′ by a separate wired connection 36′ via network interface unit 13′, and the sensor controller 22′ is part of a standalone sensor controller module 65′ that is connected to the network 14′ by a wired connection 34′ via network interface unit 67′. As with FIG. 1, however, it should be understood that one or more of the wired connections 32′, 34′, 36′, 62′ may be substituted with wireless connections using radio transceivers as desired.

The second environmental sensor 60′ of FIG. 4 may be the same as or of a different type than environmental sensor 16′. In this embodiment, the second environmental sensor 60′ is connected to the sensor controller 22′ via the wired sensor connection 62′, and may be similar to the wired sensor connection 32′. The second environmental sensor 60′ is positioned to make an environmental measurement of a second environmental characteristic 64′ of an object or area, which may be an object 20′ or may be another object 66′ or other area. In this embodiment, for example, the second environmental sensor 60′ is positioned outside the housing 30′ in order to have a larger detection area and/or line-of-sight. In some embodiments as well, one or both of the environmental sensors 16′, 60′ may be a multi-mode sensor that is capable of determining environmental characteristic values for multiple environmental characteristics 18′ of different types. One or both of the environmental sensors 16′, 60′ may also be shared among different applications in some embodiments. In this manner, multiple environmental sensors 16′, 60′ may be included with a single semi-fixed location telephone 10′ to make environmental measurements of different objects or areas.

In this embodiment, the second environmental sensor 60′ is contained in a separate housing 69′, which may be partially or completely removable from the housing 30′ of the semi-fixed location telephone 10. In this embodiment, as well, the second environmental sensor 60′ is also separately controlled by a second sensor controller 71′, or may be controlled by the sensor controller 22′. The separate housing 69′ may be configured to draw power from the main housing 30′, and/or from an integrated battery or other source. The separate housing 69′ may connect to the housing 30′ using a standardized port, such as an Ethernet port (not shown), USB port (not shown), or a custom connection, for example.

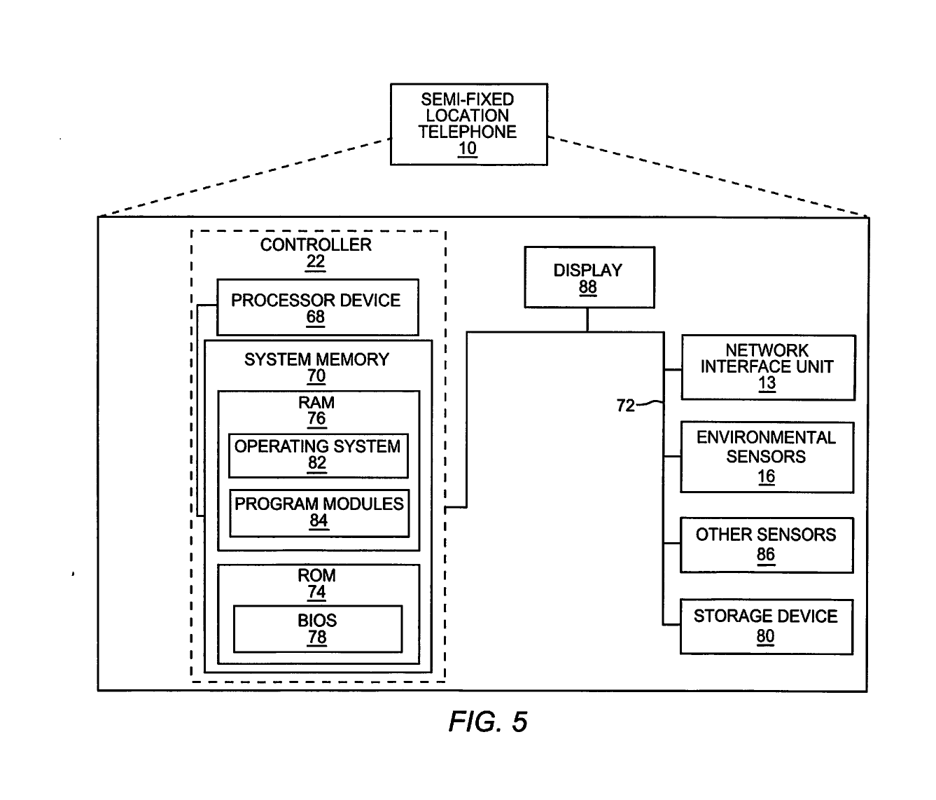

FIG. 5 is a block diagram of the semi-fixed location telephone 10 according to the embodiment of FIG. 1. It should be understood, however, that the components of Figures may be used with other embodiments herein as well. The semi-fixed location telephone 10 may comprise any computing or processing device capable of including firmware, hardware, and/or executing software instructions to implement the functionality described herein, and which is capable of being incorporated into components of the semi-fixed location telephones 10, 10′, including, for example, the processor units 15, 15′ and/or the sensor controllers 22, 22′. In this example, the semi-fixed location telephone 10 of FIG. 5 includes the sensor controller 22 having a processor device 68, a system memory 70, and a system bus 72. The system bus 72 provides an interface for system components including, but not limited to, the system memory 70 and the processor device 68. The processor device 68 can be any commercially available or proprietary processor.

The system bus 72 may be any of several types of bus structures that may further interconnect to a memory bus (with or without a memory controller), a peripheral bus, and/or a local bus using any of a variety of commercially available bus architectures. The system memory 70 may include non-volatile memory 74 (e.g., read only memory (ROM), erasable programmable read-only memory (EPROM), electrically erasable programmable read-only memory (EEPROM), etc.), and/or volatile memory 76 (e.g., random-access memory (RAM)). A basic input/output system (BIOS) 78 may be stored in the non-volatile memory 74 and can include the basic routines that help to transfer the information between the elements within the semi-fixed location telephone 10.

The semi-fixed location telephone 10 may further include a computer-readable storage device 80, which may comprise, for example, internal solid state memory, or the like. The computer-readable storage device 80 may provide non-volatile storage of the data, the data structures, the computer-executable instructions, and the like. The data structures can store historical sensor readings, which identify the sensor which made the measurement and a timestamp indicating the time the measurement was made. Computer-executable instructions may include pre-defined data processing instructions, or downloaded instructions for data processing at a specified time or interval.

A number of modules can be stored in the computer-readable storage device 80 and/or in the volatile memory 76, including an operating system 82 and one or more program modules 84, which may implement the functionality described herein in whole or in part.

In addition, the semi-fixed location telephone 10 may include additional components, such as the one or more environmental sensors 16, described in detail above, other types of sensors 86, and a display 88 or other visual indicator interface. The components of the semi-fixed location telephone 10 may interact with other components outside of the semi-fixed location telephone 10, such as a network 14 (not shown), via a network interface unit 13.

Those skilled in the art will recognize improvements and modifications to the preferred embodiments of the disclosure. All such improvements and modifications are considered within the scope of the concepts disclosed herein and the claims that follow.

1. A network-connected semi-fixed location telephone device comprising:
a telecommunication transceiver configured to provide access to a telecommunication network for a user, wherein the telecommunication transceiver is configured to allow the user to make or receive a telephone call;
at least two environmental sensors configured to determine at least two environmental characteristic values that quantifies environmental characteristics at a location outside the semi-fixed location telephone device; and
one or more sensor controllers in communication with the at least two environmental sensors, the one or more sensor controllers configured to:
receive a first environmental characteristic value from the a first environmental sensor integral to the network-connected semi-fixed location telephone device;
receive a second environmental characteristic value from a second environmental sensor exterior to the network-connected semi-fixed location telephone device but physically attached to and electrically interconnected with the semi-fixed location telephone device; and
transmit information based on the first and second environmental characteristic values to a network.

2. The network-connected semi-fixed location telephone device of claim 1, wherein the information includes location information corresponding to an installation location of the semi-fixed location telephone device.

3. The network-connected semi-fixed location telephone device of claim 1, wherein the first or second environmental characteristic is a temperature.

4. The network-connected semi-fixed location telephone device of claim 1, wherein the first or second environmental characteristic is a humidity.

5. The network-connected semi-fixed location telephone device of claim 1, wherein the first or second environmental characteristic is a sonic characteristic.

6. The network-connected semi-fixed location telephone device of claim 5, wherein the sonic characteristic is a sound of breaking glass.

7. The network-connected semi-fixed location telephone device of claim 5, wherein the sonic characteristic is a sound of a voice.

8. The network-connected semi-fixed location telephone device of claim 1, wherein the first or second environmental characteristic is an ambient light characteristic.

9. The network-connected semi-fixed location telephone device of claim 8, wherein the ambient light characteristic is selected from a group consisting of a brightness, a color, an illumination pattern, and a change in the brightness, color or illumination pattern.

10. The network-connected semi-fixed location telephone device of claim 1, wherein the first or second environmental characteristic is a presence of motion.

11. The network-connected semi-fixed location telephone device of claim 1, wherein the first or second environmental characteristic is an air quality characteristic.

12. The network-connected semi-fixed location telephone device of claim 11, wherein the air quality characteristic is an air visibility level.

13. The network-connected semi-fixed location telephone device of claim 11, wherein the air quality characteristic is a presence of smoke.

14. The network-connected semi-fixed location telephone device of claim 1, wherein the first or second environmental characteristic is a radio frequency (RF) signal.

15. The network-connected semi-fixed location telephone device of claim 1, further comprising:
a processor device; and
a memory configured to store at least one of the at least one environmental characteristic value.

16. The network-connected semi-fixed location telephone device of claim 1, wherein the sensor controller is configured to determine the information based on the first or second environmental characteristic value prior to transmitting the information to the network.

17. The network-connected semi-fixed location telephone device of claim 1, wherein the first or second environmental sensor is a plurality of environmental sensors each configured to determine a third environmental characteristic value corresponding to a different environmental characteristic.

18. A network-connected semi-fixed location telephone system comprising:
a system controller; and
a plurality of semi-fixed location telephone devices in communication with the system controller via a system network, each of the plurality of semi-fixed location telephone devices comprising:
a telecommunication transceiver configured to provide access to a telecommunication network for one or more users in communication with the telecommunication transceiver, wherein the telecommunication transceiver is configured to allow the user to make of receive a telephone call;
at least two environmental sensors configured to determine at least two environmental characteristic values that quantifies two or more environmental characteristics at a location outside the semi-fixed location telephone device; and
one or more sensor controllers in communication with the two or more environmental sensors, the one or more sensor controllers configured to:
receive a first environmental characteristic value from a first environmental sensor integral to the network-connected semi-fixed location telephone device;
receive a second environmental characteristic value from a second environmental sensor exterior to the network-connected semi-fixed location telephone device but physically attached to and electrically interconnected with the semi-fixed location telephone device; and
transmit information based on the first and second environmental characteristic values to the one or more sensor controllers to transmit the first and second environmental characteristic values to the system controller via the system network.

19. The network-connected semi-fixed location telephone system of claim 18, wherein the system network and telecommunication network are part of a common data network.

20. An environmental sensor assembly configured to be connected to a network-connected semi-fixed location telephone device, the assembly comprising:
at least two environmental sensor configured to determine at least two environmental characteristic value that quantifies two or more environmental characteristics at a location outside the semi-fixed location telephone device; and
one or more sensor controllers in communication with the at least two environmental sensor, the one or more sensor controllers configured to:
receive a first environmental characteristic value from a first environmental sensor integral to the network-connected semi-fixed location telephone device;
receive a second environmental characteristic value from a second environmental sensor exterior to the network-connected semi-fixed location telephone device but physically attached to and electrically interconnected with the semi-fixed location telephone device; and
transmit information based on the first and second environmental characteristic value to a network via the semi-fixed location telephone device.
